(19) United States
(12) Patent Application Publication
(10) Pub. No.: US 2005/0181839 A1
(43) Pub. Date: Aug. 18, 2005

(54) Devices and methods for simultaneous battery charging and data transmission in a mobile terminal

(75) Inventors: Ilkka Tiainen, Espoo (FI); Markku A. Oksanen, Helsinki (FI); Harald Kaaja, Jarvenpaa (FI); Markku Tahkokorpi, Espoo (FI); Timo K. Miettinen, Espoo (FI)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/780,203

(22) Filed: Feb. 17, 2004

(51) Int. Cl. H04Q 7/32

(52) U.S. Cl. 455/573; 455/572

(57) ABSTRACT

Devices, systems and methods are provided for simultaneous battery charging and data transfer in a mobile terminal. The invention utilizes power line communication networks to transfer data between a mobile terminal and other remote digital devices. As such, the present invention can provide data transfer to and from the mobile terminal while the mobile terminal is undergoing requisite battery charging.

### FIELD OF THE INVENTION

This invention relates to battery charging in mobile terminals, and more particularly, relates to devices and methods for simultaneous battery charging and data transmission in mobile terminals, such as mobile telephones.

### BACKGROUND OF THE INVENTION

Mobile terminals, such as mobile telephones, personal digital assistants and the like, are battery-operated devices that require periodic battery recharging. Typically battery charging requires that the user of the terminal recharge the battery once every few days. Even with the advent of faster charging batteries, recharging time typically can be anywhere between one hour and eight hours. During the recharge period the mobile terminal is typically limited in terms of functionality and is generally in a stationary position that provides very limited mobility.

Additionally, mobile terminals typically utilize a data transfer function that provides for data to be transferred to the mobile terminal and for data to be transferred from the mobile terminal. For example, audio (i.e., music) files are typically transferred to a mobile terminal and image files captured by the mobile terminal are typically transferred to a personal computer or laptop computer that may execute an image storage application. In each instance, application specific software must be loaded on the transferring devices to provide the requisite instructions for transferring the data. In many instances the transfer of data occurs routinely, such as on a daily basis. Traditionally, the communication medium for this type of data transfer has been over a serial type connection, such as Universal Serial Bus (USB) or the like. More recently, short-range wireless communication techniques such as Bluetooth®, Wireless Local Area Network (WLAN) and the like have been implemented to transfer data between digital devices.

As previously noted, in mobile terminals the battery charging period is typically lengthy and typically an inactive period in terms of terminal functionality. However, the battery charging period provides for an ideal time to transfer data to or from the mobile device since the terminal is not otherwise being used. While mobile terminals have incorporated dual battery chargers and data transfer mechanisms, these devices have been limited to data transfer between a mobile terminal and another device, such as a PC or laptop, that is in close proximity to the mobile terminal. Close proximity has been warranted because the data transfer is accomplished using either a serial type connection, such as a USB connector, or short-range wireless communication. However, the users of mobile terminals would greatly benefit from being able to transfer data remotely, either to and from any digital device in a home network or beyond the home to other remote networked devices. Such networked data transfer would allow the user to transfer data to and from multiple devices simultaneously and would allow for the transfer regardless of the physical proximity of the transferor or transferee device. In addition to mobile terminal users, mobile service providers and/or terminal manufacturers would benefit from being able to remotely access and/or manage mobile terminals from remote network devices.

Recently, power line communication networks are becoming more prevalent. Power line communication networks can be implemented in a relatively small area, such as within a dwelling or a business office building and require minimal architecture. See for example World Organization (WO) Patent Publication No. 0135544, entitled, “Communication System, Especially for Indoors”, Ascom Powerline Communications AG, Nov. 11, 1999. Additionally, power line communication can form the physical layer of a more comprehensive network and, thus, provide for communication over a wider area. See for example, U.S. Pat. No. 6,130,896 entitled, “Wireless LAN Segments with Point Coordination”, issued in the name of inventors Lueker et al., issued Oct. 10, 2000.

Thus, a need exists to develop a device, system and methods for mobile terminal data transfer and data synchronization that can easily and efficiently transfer data with remote devices while the mobile terminal is undergoing battery charging. Additionally, the need exists to create a device, system and methods that provide dual functionality to a mobile terminal that is in a stationary idle state due to requisite battery charging. Lastly a need exists to implement newly developed network architectures, such as power line communication networks, to create local networks of mobile terminals and to create additional options for data transfer and terminal synchronization.

### BRIEF SUMMARY OF THE INVENTION

The present invention provides devices, systems and methods for simultaneous battery charging and data transfer in a mobile terminal. The invention utilizes power line communication networks to transfer data between a mobile terminal and other remote digital devices. As such, the present invention can provide data transfer to and from the mobile terminal while the mobile terminal is undergoing requisite battery charging.

In a first embodiment, a device for providing a mobile terminal simultaneous battery charging and data transfer is defined. The device includes a processing unit and a power line communication modem in communication with the base band processing unit and a shared power line network. The processing unit and the power line communication modem provide the ability to modulate and demodulate data for communication to and from the mobile device across the power lines. The device may additionally include a data transfer interface in communication with the processor that provides for data transfer between the device and a mobile terminal. The data transfer interface may be wired interface, such input/output contacts or the interface may be a wireless interface, in the form of a communication specific transceiver.

The device will additionally include a power converter in communication with the shared power line network and a charging unit and interface in communication with the power converter. The charging interface will typically be a wired interface that is provided in unison with the data transfer interface.

The device may also include a memory unit in communication with the base band processor. The memory unit may be internal to the device or external in the form of a memory card or the like. The memory unit may serve to temporarily store the data transferred, store sub-network identification and terminal associations, and other relevant information. Alternate embodiments of the device may implement a file deletion routine executed by the processor that provides for idle files to be deleted from an associated mobile terminal.

The invention is further defined by a system for providing a mobile terminal simultaneous battery charging and data transfer. The system includes a mobile terminal, a first datacharger device, a shared power line network and a digital device that is in network communication with the mobile terminal via the datacharger device. The first datacharger device includes a processing unit, a power line communication modem in communication with the processing unit and the shared power line network, a power converter in communication with the shared power line network and a charging unit in communication with the power converter.

The system may additionally include a data transfer device that is in communication with the digital device and includes a processing unit and a power line communication modem in communication with the base band processing unit and the shared power line network. The data transfer device may take the form of a second datacharger device or a power line network adapter, such as a Universal Serial Bus (USB) adapter.

The invention is additionally embodied in a method for power line communication of data between a digital device and a mobile terminal while simultaneously charging a battery of the mobile terminal. The method includes the steps of connecting a battery charging and data communication device (i.e. a datacharger) to a power line, connecting the mobile terminal to a charging interface and a data communication interface of the datacharger and providing power to the battery of the mobile terminal. Additionally, the method includes the step of communicating data between the mobile terminal and a digital device, whereby the data is communicated via the power line and the digital device is in communication with the power line.

The method may further include the step of authorizing the mobile terminal for data communication prior to communicating data between the mobile terminal and the digital device. Authorization may entail querying the mobile terminal for a pairing key to determine if the mobile device is authorized for data communication and authorizing the mobile terminal upon receipt by the datacharger of the pairing key. The method may further include the step of synchronizing the data communicated between the mobile terminal and the digital device. Synchronization may include creating sub-network association for the mobile terminal and the datacharger or selecting, from a stored list of sub-networks, sub-network association for the mobile terminal and the datacharger.

The step of communicating data between the mobile terminal and a digital device may include various forms of data communication. In one embodiment, the method communicates, from the mobile terminal to a digital device, multimedia files created at the mobile terminal. Multimedia files may include image files, audio files, video files, or the like. In another embodiment, the method communicates, from the digital device to the mobile terminal, electronic mail that is received by the digital device or calendar-type information relevant to a personal planner application implemented on the mobile terminal. In yet another embodiment, the method communicates, from the digital device to the mobile terminal, updates to software applications implemented on the mobile terminal.

Thus, the present invention provides for devices, systems and methods for affording a mobile terminal simultaneous battery charging and data transfer/synchronization. As such, the user of the mobile terminal benefits from greater efficiency in providing for typically lengthy data transfer functions during a period in which the mobile terminal is stationary and typically inoperative (i.e., the battery charging period). Additionally, the present invention utilizes power line communication networks to create sub-networks within a specified environment, thus allowing the datacharger to transfer data amongst multiple mobile terminals and multiple digital devices within the specified environment.

### BRIEF DESCRIPTION OF THE DRAWINGS

Having thus described the invention in general terms, reference will now be made to the accompanying drawings, which are not necessarily drawn to scale, and wherein:

FIG. 1 is perspective illustration of a configuration of a device for providing a mobile terminal simultaneous battery charging and data transfer, in accordance with an embodiment of the present invention.

FIG. 2 is block diagram of a device for providing a mobile terminal simultaneous battery charging and data transfer, in accordance with an embodiment of the present invention.

FIG. 3 is a block diagram of system for providing a mobile terminal simultaneous battery charging and data transfer, in accordance with an embodiment of the present invention.

FIGS. 4A-4C illustrate various routines for associating mobile terminals with datacharger devices, in accordance with an embodiment of the present invention.

FIG. 5 is a flow diagram of a method for communicating data between a mobile terminal and a digital device via a power line communication and implementing a datacharger, in accordance with an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The present invention provides for devices, systems and methods for simultaneous battery charging and data transfer in a mobile terminal, such as a mobile telephone, a personal digital assistant (PDA) or the like. The invention implements conventional power line communication means to provide for devices, systems and methods that are capable of simultaneous battery charging and data transfer, such as downloading, uploading or synchronization of the data or applications associated with the mobile terminal. In this regard, the invention efficiently utilizes the idle time associated with charging the mobile terminal battery to transfer data to and from the mobile terminal.

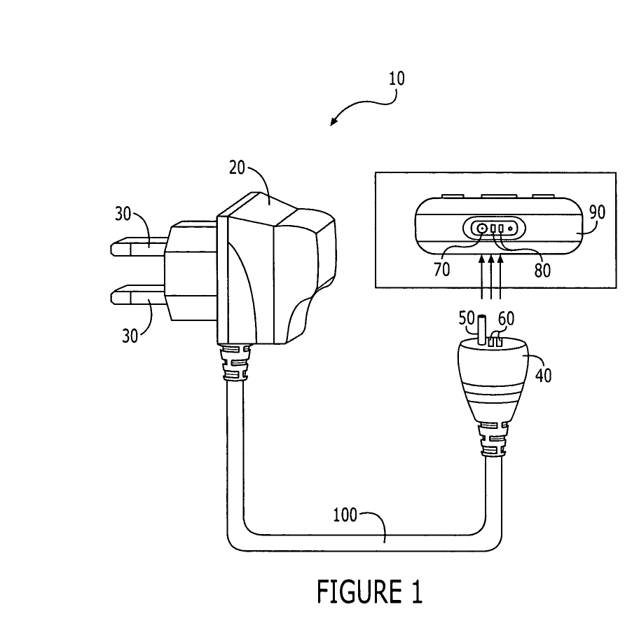

FIG. 1 provides an illustration of an example of a configuration of a device for simultaneous battery charging and data transfer in a mobile terminal, in accordance with an embodiment of the present invention. The device 10, referred to herein as a “datacharger” includes a base unit 20 that will include modulation and demodulation circuitry and a power converter. The base unit includes electrical plugs 30 that connect the base unit to a shared power line network. Additionally the datacharger will include a mobile terminal connector 40 that includes a power plug 50 and data transfer input/output (I/O) contacts 60. The power plug and the I/O contacts are configured to mate with corresponding power inlet 70 and I/O contacts 80 of mobile terminal 90. The base unit and the mobile terminal connector are connected via cable 100, which may be a standard Universal Serial Bus (USB) cable.

In an alternate embodiment, the datacharger may be configured in a conventional cradle type apparatus. In the cradle-type apparatus the base unit and the mobile terminal connector are housed in a unitary structure and a receiving compartment for the mobile terminal is provided for making power contact and data transfer contact between the mobile terminal and the datacharger. Typically, in cradle-type apparatus embodiments an electrical cord will be connected to the cradle-type apparatus to provide for electrical connection with an electrical outlet. In yet another alternate configuration the base unit may be configured to provide for wireless data transfer between the mobile terminal and the base unit. A conventional wireless communication medium such as Bluetooth®, Infrared (IR), Radio Frequency (RF), Ultra Wide Band (UWB), Wireless Local Area Network (WLAN) or the like may be implemented to provide wireless data transfer between the base unit and the mobile terminal.

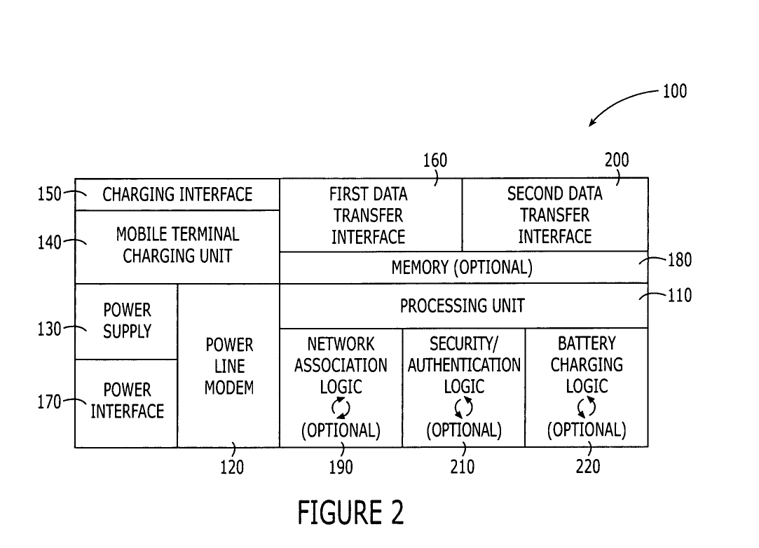

FIG. 2 provides a block diagram of a device for simultaneous battery charging and data transfer, in accordance with an embodiment of the present invention. The datacharger device 100 will include a base band processing unit 110 and a power line communication modem 120 that is in communication with the processing unit. The base band processing unit is responsible for managing the communications protocol between the shared power line network and the mobile terminal. In one embodiment, the datacharger device may implement Carrier Sense Multiple Access/Collision Detection (CSMA/CD) protocol to allow for communication to occur amongst the shared medium and allow for collisions to be detected with appropriate exponential back-off. The power line communication modem is responsible for modulation and demodulation of the data that is being transferred to the mobile terminal from the shared power line network or transferred from the mobile terminal to the shared power line network.

The datacharger device will additionally include a power converter 130, typically an alternating current/direct current (AC/DC) power converter and a mobile terminal charging unit 140 that is in communication with the power converter. The power converter is responsible for converting the direct current from the power line into alternating current for the battery and supplying power to the data communication functions. The charging unit is responsible for transferring the alternating current from the datacharger to the battery of the mobile terminal.

The datacharger device will also include a charging interface 150, a first data transfer interface 160 and a power interface 170. The charging interface provides for a battery charging connection point between the datacharger and the mobile terminal. The charging interface may be configured in a connector that plugs into the mobile terminal, as in FIG. 1, or it may be housed in a mobile terminal receiving-cavity of a cradle-type unit.

The datacharger may be configured to automatically charge the mobile terminal that is connected to the datacharger or the datacharger may include battery logic 220 executed by the processing unit 110 that determines whether the mobile terminal requires charging. For example, the battery logic may be configured to provide charging only if the current charging level is below 50% of the maximum charge level. Limiting the amount of charging cycles will typically increase the life of the battery.

The first data transfer interface 160 provides for a data transmission point between the datacharger and the mobile terminal. The first data transfer interface may be a wired or wireless connection. In a wired connection, the first data transfer interface will typically be configured along with the charging interface 150; either in a USB-type serial connector that plugs into the mobile terminal or housed in a mobile terminal receiving-cavity of a cradle-type unit. In wireless embodiments, the first data transfer interface will include a communications transceiver, such as a Bluetooth® transceiver, an Infrared (IR) transceiver, a Radio Frequency (RF) transceiver, an Ultra Wide Band (UWB) transceiver, a Wireless Local Area Network (WLAN) transceiver or the like. In certain embodiments, the first data transfer interface may have both a wired and wireless connection. The wireless connection allows for data transfer and/or synchronization to occur when the mobile terminal is in the vicinity of the datacharger but not electrically connected to the charging unit.

The power interface 170 is responsible for providing direct current from the power line network to the datacharger device. The power interface will typically include an electrical plug that is connected to the shared power line network via an electrical outlet. The power interface may additionally include an electrical cord or other means of conveying electrical power to the datacharger device 100 and, more particularly, to the power converter 130 and, in turn, the charging interface 150 of the datacharger device.

The datacharger device 100 may additionally include a memory unit 180 that is in communication with the base band processing unit 110. The memory unit can provide for permanent or temporal storage of data that is being transferred from or to the mobile terminal. The memory unit may be internal to the datacharger device or it may be external to the datacharger device, in the form of a memory expansion interface, such as a multi-media memory card with or without short-range wireless communication capacity. Additionally, the memory unit may store information related to sub-networks created by the mobile terminal user. Further description of the creation of sub-networks is included later in the detailed discussion.

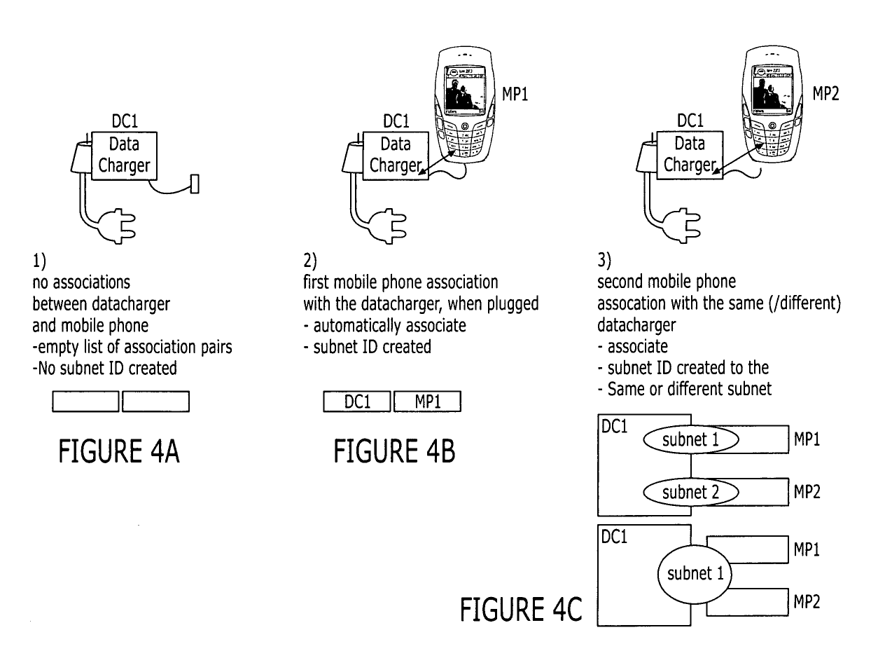

Additionally, the processing unit 110 may execute optional network and association logic 190 that associates mobile terminals and data sources with the datacharger and creates sub-networks for the associated devices. For a more detailed description of the creation of sub-networks and association see the description related to FIG. 4. In addition, in those embodiments that implement network and association logic the memory unit 180 will typically include an association database that lists mobile terminals and data sources associated with the datacharger and the associated sub-networks.

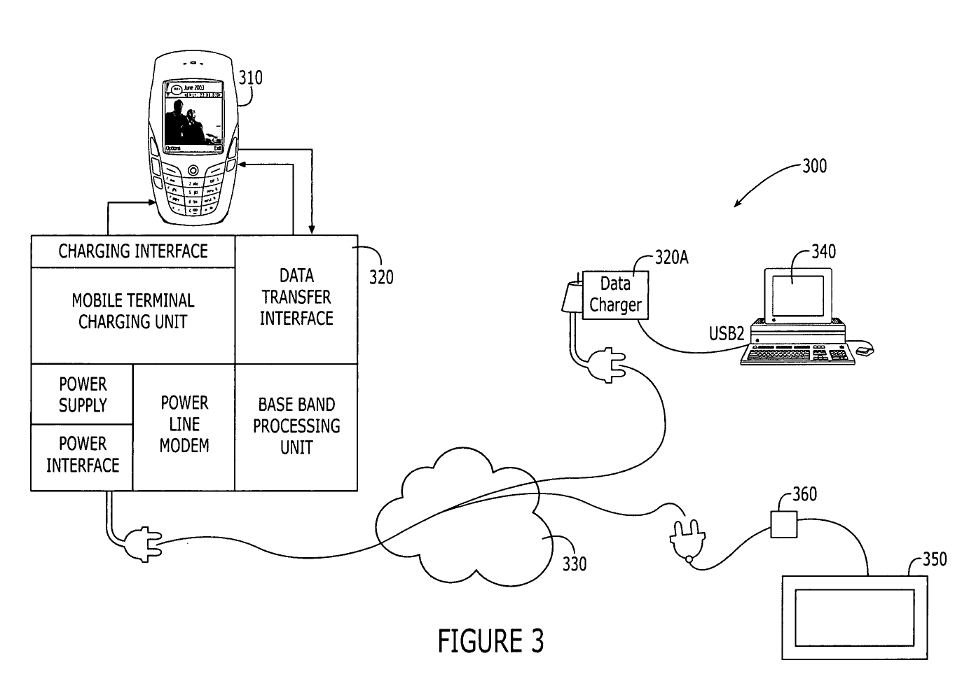

The datacharger device 100 may additionally include a second data transfer interface 200 that provides for data transmission between a data source, such as a personal computer or server, and the datacharger. In embodiments in which the datacharger incorporates a second data transfer interface, the datacharger is used to process data that is being communicated from the data source to the shared power line network or from the shared power line network to the data source. For further description see FIG. 3 and the description related to datacharger 320A. The second data transfer interface may be a wired or wireless connection. In a wired connection, the second data transfer interface will typically be a USB2 type connector that extends from the datacharger and plugs into the data source via suitable USB connector. In wireless embodiments, the second data transfer interface will include a communications transceiver, such as a Bluetooth® transceiver, an Infrared (IR) transceiver, a Radio Frequency (RF) transceiver, an Ultra Wide Band (UWB) transceiver, a Wireless Local Area Network (WLAN) transceiver or the like. In certain embodiments, the second data transfer interface may have both a wired and wireless connection. The wireless connection allows for data transfer and/or synchronization to occur when the data source is in the vicinity of the datacharger.

Also, the datacharger may include a security and/or authentication routine 210 executed by the processing unit 110. The security portion of the routine may encompass encryption/decryption of data that is transferred from or to a data source and a mobile terminal. Additionally, authentication may involve authentication of the mobile terminal or the data source prior to transferring data to and from the mobile terminal.

FIG. 3 depicts a system for simultaneous mobile terminal battery charging and data transfer, in accordance with an embodiment of the present invention. The system 300 includes a mobile terminal 310 that is in communication with a first datacharger device 320. Data transfer communication between the mobile terminal and the datacharger device may be wired or wireless as discussed above. The first datacharger device will be in communication with the shared power line network 330. The architecture necessary to construct a shared power line communication network is well known by those of ordinary skill in the art and is not shown or described herein for the sake of brevity.

The system further includes a first digital device 340, such as a personal computer, server or the like. The first digital device is in communication with a second datacharger 320A. In this system embodiment the datacharger is used to process data that is being communicated from the first digital device to the shared power line network or from the shared power line network to the first digital device. Since, in this instance, the personal computer is illustrated as a desktop computer that does not implement battery power, the charging function of the datacharger is not applicable. However, a laptop computer or other mobile PC may also desire battery recharging capability. As such, while a datacharger is shown in the FIG. 3 embodiment, it is also possible to provide for another conventional adapter that provides for data to be transmitted from the shared power line network to and from the first digital device. The conventional adapter may be a stand-alone device or it may be physically incorporated within the first digital device. Data transfer communication between the first digital device and the datacharger device may be wired, typically USB connectors, or wireless, via the applicable transceiver, as discussed above. The second datacharger device will be in communication with the shared power line network 330. In this system, the first digital device may transfer data to the mobile terminal through the shared power line network or the mobile terminal may transfer data to the first digital device through the shared power line network.

The system may further include a second digital device 350, such as a television monitor. The second digital device is in communication with a shared power line network adapter 360. The network adapter processes data that is being communicated between the second digital device and the shared power line network. Data transfer communication between the second digital device and the network adapter device may be wired, typically via USB connector, or wireless, via an appropriate transceiver. While the network adapter is depicted as a stand-alone unit, the network adapter may also be internal to the second digital device. In this system, the mobile terminal will typically transfer data to the second mobile terminal. For example, the mobile terminal may be equipped with a digital camera device and may transfer image files to the second digital device; i.e., the television monitor, for appropriate display of the images. It may also be possible for the second digital device to transfer data to the mobile terminal.

In order for a mobile terminal to transfer data to and from another digital device in the power line network, the mobile terminal must be in communication with the datacharger device and, to insure safe transfer of data, the mobile terminal may require network association with the digital device that it will transfer data to and/or receive data from. Without network association (i.e., secure sub-networks) it is possible for communicated data to be received by other, unintended, devices that are capable of power line communications. With network association, the data communicated between devices within a particular sub-network may be masked or encrypted with a dedicated association key or algorithm, which prevents possible eavesdroppers from utilizing the received data. The relevant association secrets may be provided to each of the devices belonging to a certain sub-network through wireless short-range communication interface (i.e. a mobile terminal acting as a “sub-network master” provides the association secret when within wireless short-range communication coverage of the devices) in order to ensure that other devices connected to the power line communication network do not have any means to acquire the association secrets and interfere with communications within the sub-network.

In one embodiment of the invention, the processing unit of the datacharger will execute network association logic. In alternate embodiments the network association may be embodied and executed in a mobile terminal or in another network device. Typically, network association between a data source and the datacharger will be through a USB interface, an Ethernet interface or the like. However, as depicted in FIG. 2, association of a remote digital device 350 that incorporates a power line network adapter 360 for data transmission through the shared power line network 330 may be accomplished at the Internet Protocol (IP) layer or Ethernet level. In this instance, an association protocol engine is required at the datacharger, and possibly at the remote digital device, to query the static information from the digital device (i.e., IP address or MAC address, etc.).

The association application allows the user of the mobile terminal to create or choose to associate with sub-networks that are specific to different mobile terminals and digital devices in the power line network. Typically, the association application will provide for a displayable user interface that allows the mobile terminal user to choose association options as they are displayed on the Graphical User Interface (GUI).

FIGS. 4A 4C illustrate examples of how mobile terminals are associated with datacharger specific sub-networks, in accordance with an embodiment of the present invention. FIG. 4A illustrates a newly implemented datacharger device (referred to as DC1) that has yet to be associated with a mobile terminal. As such, the memory unit of the datacharger has no association pairs and no sub-network IDs have been created. FIG. 4B illustrates an example of a datacharger device that has been associated with a first mobile terminal (referred to as MP1). This association may occur automatically when the mobile terminal first communicates with the datacharger. The association application will create initial encryption keys and sub-network identification (ID), typically in the form of a name or number. In the illustrated example, the association application has created sub-network ID, sub-network 1, for the association of the datacharger to the first mobile terminal and the sub-network ID is stored at the datacharger.

FIG. 4C illustrates an example of datacharger device, DC1, that has been associated with a second mobile terminal (referred to as MP2). This association occurs manually, at the request of the user of the second mobile terminal. Once the user of the second mobile terminal has chosen to associate the terminal with the datacharger, the user may choose to join the preexisting sub-network (i.e., sub-network 1) or the user may choose to create a new sub-network. In the illustrated embodiment if the user chooses to create a new sub-network, the association application creates new encryption keys and sub-network ID, in this instance sub-network 2, has been created.

Additionally, the datacharger device of the present invention may execute a security/authentication routine. The security/authentication routine provides for an initial pairing of a datacharger and a mobile terminal, typically the pairing will occur at the inception of the use of the datacharger. Pairing of the datacharger to a mobile terminal provides authentication to the mobile terminal, thus, allowing the mobile terminal to use the communication modules of the datacharger. In one example, pairing of the datacharger to the mobile terminal may entail, connecting a mobile terminal to the datacharger and entering a Personal Identification Number (PIN) code into the datacharger. Pairing may occur via a wireless or wired connection. Other mobile devices may use the same datacharger for data transfer, if the other digital devices are capable of providing the requested PIN code, or alternatively, the datacharger may be configured to allow all mobile terminals to communicate through the datacharger. After successful pairing of a datacharger and a mobile terminal, a pairing key is stored on both the datacharger and the mobile terminal and the datacharger will request the pairing key, upon connection, to provide the mobile terminal with communication services.

In one embodiment of the invention the datacharger may execute a routine to delete idle files, such as image files, previously read or sent Short Messaging Service (SMS) messages, single-use-applications or the like. The routine will identify idle files based on content and how long they have been stored on the mobile device. The datacharger can then automatically delete the files from the datacharger or the datacharger can provide the user, through the GUI, options for deleting or retaining files identified as delete-able. In certain embodiments in which, the datacharger is not connected to a power line; the battery in the mobile terminal may be used as the power source for deleting idle files. However, in typical embodiments the deletion of idle file routine will be powered by the internal datacharger power supply (i.e., the power line).

In another embodiment of the invention, the datacharger may come equipped with a game application that is uploaded to the mobile terminal upon successful completion of the initial configuration process by the mobile terminal user. The datacharger will typically require the mobile terminal to upload configuration files to the mobile terminal. The game upload option provides the user of the mobile terminal incentive to perform the configuration and otherwise become familiar with the functionality of the datacharger device.

The datacharger device and system of the present invention provide for multiple methods of use, in accordance with embodiments of the present invention. In a first method of use, the datacharger is utilized to routinely download image files captured by the mobile terminal to a more robust application, such as a digital photo album application that is executed on a personal computer or a laptop computer. As such, the user of the mobile terminal can capture images, temporarily store the images in the mobile terminal and then, downloaded them to the PC or laptop application, typically during a normal battery recharge routine. In this method of use, download of the image files will occur automatically, without the user of the mobile terminal having to designate files for downloading or otherwise interface with the mobile terminal prior to transferring the files. Additionally, in this use embodiment, the user can remotely download image files to a PC or laptop as opposed to the conventional means of downloading the image files, via a serial type connection, in which the mobile terminal and PC or laptop are in the same general vicinity (i.e., same room or desktop).

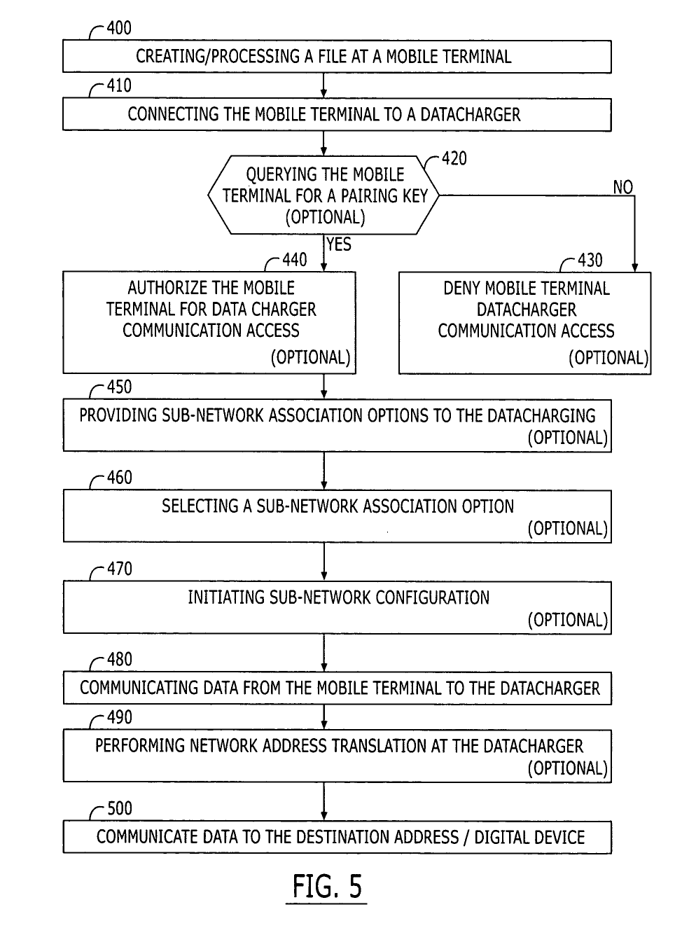

FIG. 5 provides a flow diagram of a method for routinely downloading media files from a mobile terminal to a digital device executing a more robust diary or organizational application. At step 400, a mobile terminal either creates or possesses a file, such as a multimedia file, for example, an image file, an audio file, a video file or the like. At step 410, the mobile terminal is connected, physically or wirelessly, with the datacharger. An optional authentication process may ensue, at step 420, whereby the datacharger queries the mobile terminal for a pairing key to decide whether the mobile terminal is authorized for using datacharger communications. If the mobile terminal does not include the pairing key then, at step 430, the mobile terminal is denied access to the datacharger communications. However, if the mobile terminal includes the pairing key then at step 440, the mobile terminal is authorized to use the datacharger communications.

At optional step 450, the mobile terminal provides sub-network association options for the datacharger to allow the mobile terminal user to select an appropriate sub-network for data synchronization and at step 460 the mobile terminal user selects an appropriate sun-network association option. At step 470, the datacharger initiates sub-network configuration for allowing communication in the network. At step 480, the mobile terminal provides data, in the form of the multimedia file, to the datacharger with a corresponding, mobile-terminal provided, destination address. Upon receipt of the data by the datacharger, at optional step 490, the datacharger may require execution of a network address translation (NAT) routine to determine the actual destination address based on the received destination address. At step 500, the datacharger will transmit the data to the destination using either the received destination address or the translated destination address.

In addition, to the embodiment discussed above in relation to FIG. 4, it is possible for the datacharger device of the present invention to routinely download information from a digital device, such as a PC or the like, to the mobile terminal. For example, routine synchronization of the mobile terminal may involve transferring data electronic mail, calendar information or the like from a PC to the mobile terminal.

In a second method of use the datacharger device is implemented to download, from a PC, server or the like updates, patches or the like to software applications that are executed on the mobile terminal. The software provider, or the manufacturer of the mobile terminal may be able to connect with the datacharger through a network that includes the power line as the physical layer. Thus, updates, revisions and patches to software can be communicated to the mobile terminal via the datacharger. The mobile terminal may receive the updates during a battery charging session or the data charging device may receive the updates, temporarily store them and communicate them to the mobile device via conventional short-range wireless communication techniques.

Thus, the present invention provides for devices, systems and methods for affording a mobile terminal simultaneous battery charging and data transfer/synchronization. As such, the user of the mobile terminal benefits from greater efficiency in providing for typically lengthy data transfer functions during a period, in which the mobile terminal is stationary and typically inoperative (i.e., the battery charging period). Additionally, the present invention utilizes power line communication networks to create sub-networks within a specified environment, thus allowing the datacharger to transfer data amongst multiple mobile terminals and multiple digital devices within the specified environment.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the cope of the appended claims. Although specific terms are employed herein, they are used in a generic and descriptive sense only and not for purposes of limitation.

1. A device for providing a mobile terminal simultaneous battery charging and data transfer, the device comprising:
a processing unit;
a power line communication modem in communication with the processing unit and a shared power line network;
a first data transfer interface in communication with the processing unit for transferring data to and from the mobile terminal;
a power converter in communication with the shared power line network; and
a charging unit and interface in communication with the power converter,
wherein the charging interface and the data transfer interface provide for communication with a mobile terminal to provide the mobile terminal with simultaneous battery charging and data transfer.

2. The device of claim 1, further comprising a memory unit in communication with the processing unit.

3. The device of claim 1, wherein the first data transfer interface further comprises a data Input/Output (I/O) interface.

4. The device of claim 1, wherein first data transfer interface further comprises a Universal Serial Bus interface.

5. The device of claim 1, wherein the first data transfer interface further comprises a wireless data transfer interface.

6. The device of claim 5, further comprising a short-range communication transceiver.

7. The device of claim 6, wherein the short-range communication transceiver is chosen form the group consisting of an RF transceiver, an Infrared (IR) transceiver, a Wireless Local Area Network (WLAN) transceiver, and an Ultra Wide Band (UWB) transceiver.

8. The device of claim 1, further comprising a second data transfer interface in communication with the processing unit that transfers data to and from a data source device.

9. The device of claim 1, further comprising a network association routine executed by the processing unit that associates one or more mobile terminals with the device.

10. The device of claim 9, wherein the network association routine further associates one or more digital devices with the device to create sub-networks.

11. The device of claim 10, further comprising an association database that stores an identity of one or more mobile terminals associated with the device.

12. The device of claim 10, further comprising an association database that stores an identity of one or more digital devices associated with the device.

13. The device of claim 1, further comprising a security and authentication routine executed by the processing unit that provides authentication for one or more mobile units.

14. The device of claim 1, further comprising a battery charging routine executed by the processing unit that provides conditional battery charging based on current battery level.

15. The device of claim 1, further comprising a file deletion routine executed by the processing unit that provides for idle files to be automatically deleted from an associated mobile terminal based on period of idleness.

16. The device of claim 2, further comprising a game application stored in the memory unit that can be uploaded by the mobile terminal.

17. A system for providing a mobile terminal simultaneous battery charging and data transfer, the system comprising:
a mobile terminal;
a first datacharger device that provides for simultaneous battery charging and data transfer to the mobile terminal, which includes a processing unit, a power line communication modem in communication with the processing unit, a first data transfer interface in communication with the processing unit and a charging unit in communication with the power converter;
a shared power line network in communication with the first datacharger via the power line communication modem and the power converter; and
a first digital device in communication with the shared power line network that transfers data to the mobile terminal through the shared power line and the first data transfer interface of the first datacharger device.

18. The system of claim 17, further comprising a second digital device in communication with the first datacharger through a second data transfer interface included in the first datacharger device.

19. The system of claim 18, wherein the first datacharger device includes a second data transfer interface further defined as a wireless second data transfer interface.

20. The system of claim 18, wherein the first datacharger device further comprises a short-range communication transceiver.

21. The system of claim 20, wherein the short-range communication transceiver is chosen form the group consisting of an RF transceiver, an Infrared (1R) transceiver, a Wireless Local Area Network (WLAN) transceiver, and an Ultra Wide Band (UWB) transceiver.

22. The system of claim 17, further comprising a network association routine executed by the processing unit that associates one or more mobile terminals with the device.

23. The system of claim 22, wherein the network association routine further associates one or more digital devices with the device to create sub-networks.

24. The system of claim 17, further comprising a security and authentication routine executed by the processing unit that provides authentication for one or more mobile units.

25. The system of claim 17, further comprising a data transfer device that is in communication with the digital device and includes a processing unit and a power line communication modem in communication with the processing unit, a first data transfer interface in communication with the processing unit and the shared power line network.

26. The system of claim 25, wherein the data transfer device is further defined as a second datacharger device that further comprises a power converter in communication with the shared power line network and a charging unit in communication with the power converter.

27. The system of claim 25, wherein the data transfer device further comprises a Universal Serial Bus (USB) connection for providing USB connection to the digital device.

28. The system of claim 17, further comprising a Universal Serial Bus (USB) adapter device in communication with the shared power line network and the digital device.

29. A method for power line communication of data between a digital device and a mobile terminal while simultaneously charging a battery of the mobile terminal, the method comprising the steps of:
connecting a battery charging and data communication device to a power line;
connecting the mobile terminal to a charging interface and a data communication interface of the battery charging and data communication device;
providing power to the battery of the mobile terminal; and
simultaneously, communicating data between the mobile terminal and the digital device, whereby the data is communicated via the power line and the digital device is in communication with the power line.

30. The method of claim 29, further comprising the step of authorizing the mobile terminal for data communication prior to communicating data between the mobile terminal and the digital device.

31. The method of claim 30, wherein the step of authorizing the mobile terminal for data communication prior to providing data to the mobile terminal further comprises querying the mobile terminal for a pairing key to determine if the mobile device is authorized for data communication.

32. The method of claim 31, further comprising the step of communicating, wirelessly, the pairing key from the mobile terminal to the battery charging and data communication device to provide for data communication authorization.

33. The method of claim 29, further comprising the step of synchronizing the data communicated between the mobile terminal and the digital device.

34. The method of claim 33, wherein the step of synchronizing the data communicated from the mobile terminal further comprises creating sub-network association for the mobile terminal and the battery charging and data communication device.

35. The method of claim 34, wherein the step of synchronizing the data communicated from the mobile terminal further comprises selecting, from a stored list of sub-networks, sub-network association for the mobile terminal and the battery charging and data communication device.

36. The method of claim 29, wherein the step of communicating data between the mobile terminal and a digital device further comprises the step of communicating data and a mobile terminal-provided destination address to the battery charging and data communication device.

37. The method of claim 36, further comprising the step of performing network address translation on the mobile terminal-provided destination address prior to communicating the data to the digital device.

38. The method of claim 29, wherein the step of communicating data between the mobile terminal and a digital device further comprises communicating, from the mobile terminal to a digital device, multimedia files created at the mobile terminal.

39. The method of claim 29, wherein the step of communicating data between the mobile terminal and a digital device further comprises communicating, from the digital device to the mobile terminal, electronic mail that is received the digital device.

40. The method of claim 29, wherein the step of communicating data between the mobile terminal and a digital device further comprises communicating, from the digital device to the mobile terminal, updates to software applications implemented on the mobile terminal.

41. The method of claim 29, wherein the step of communicating data between the mobile terminal and a digital device further comprises communicating, from the digital device to the mobile terminal, calendar-type information related to a digital planner application.
